(19) United States
(12) Patent Application Publication
(10) Pub. No.: US 2017/0061835 A1
(43) Pub. Date: Mar. 2, 2017

(54) PERSONAL INFORMATION TAG

(71) Applicant: Cosmin Popa, Bellevue, WA (US)

(72) Inventor: Cosmin Popa, Bellevue, WA (US)

(21) Appl. No.: 14/841,605

(22) Filed: Aug. 31, 2015

(51) Int. Cl. G09F 7/10; G09F 7/12; G09F 3/02

(52) U.S. Cl. CPC G09F 7/10; G09F 3/02; G09F 7/12

(57) ABSTRACT

A method and an article of manufacture are disclosed for making and using a configurable information tag in a crowded setting, such as a large classroom or a conference. In various embodiments, a transparent case, a thin frame, or sheet material, such as cardboard, plastic, laminates, and the like is used to create an information tag, such as a nametag, suitable for placing, substantially vertically, on a table or a desk for quick and easy identification of the user.

### CROSS-REFERENCE(S) TO RELATED APPLICATION(S)

This Non-Provisional application is a Continuation-In-Part of the U.S. Non-Provisional patent application Ser. No. 13/851,940, filed on 27 Mar. 2013, entitled “CONFIGURABLE AND EXTENDABLE INFORMATION TAG,” the disclosure of which is hereby expressly incorporated by reference in its entirety, and the benefit of the priority dates of which is hereby claimed.

### TECHNICAL FIELD

This application relates generally to information display tags. More specifically, this application relates to a configurable name tags for use in a classroom or in a conference, to identify a person.

### BRIEF DESCRIPTION OF THE DRAWINGS

The drawings, when considered in connection with the following description, are presented for the purpose of facilitating an understanding of the subject matter sought to be protected.

FIG. 1 shows an example large class environment where a configurable information tag may be used;

FIG. 2 shows an example laptop computer with a configurable information tag displaying a name;

FIG. 3 shows an example laptop computer with a protective case having a built-in configurable information tag displaying a name;

FIG. 4 shows an example configurable information tag with a slot for sliding in a paper label;

FIG. 5A shows an example information tag having a folded hanging edge;

FIG. 5B shows an example information tag with an adhesive side;

FIG. 5C shows an example information tag with rotating hanging hooks;

FIG. 6A shows an example extendable information tag configured to be slid up and down to increase visibility;

FIG. 6B shows an example extendable information tag configured to be rotate or flip up and down to increase visibility;

FIG. 7A shows an example information tag with slotted holes configured for placing the information tag into a three-ring binder without opening the rings;

FIG. 7B shows the example information tag of FIG. 7A as placed in the three-ring binder without opening the rings;

FIG. 8 shows an example information tag having two holes and a slot to hold pens and pencils that act as stands for the tag; and

FIG. 9 shows an example information tag having two slits to hold credit cards and business cards that act as stands for the tag; and

FIG. 10 shows an example information tag having one open hole and one open slit.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while the following description references information tag used on laptop computers, it will be appreciated that the disclosure may include other types of uses of the information tag, such as with books, tablet computers, notebook computers, table edge, and the like.

Briefly described, a method and an article of manufacture are disclosed for making and using a configurable information tag to support easy user identification in a crowded setting, such as a large classroom. In various embodiments, a transparent case, a thin frame, or sheet material, such as cardboard, plastic, laminates, and the like is used to create an information tag, such as a nametag, suitable for attaching to the back of a laptop computer for quick and easy identification of the laptop user by others. In various embodiments, the configurable information tag may include a folded transparent plastic sheet, a sheet with a folded edge, and an adhesive sheet. In some embodiments, the configurable information tag may be extendable to increase the display height for further improving visibility.

With the ubiquity of laptop, tablet, and other portable computers, more and more people carry these devices to various training or public discourse locations for taking notes, studying, or accessing various information. For example, a student may take his laptop to a classroom for taking notes or referencing written material; an employee may take his computer to a seminar or a training session; or an engineer may take his laptop to a professional workshop. In each of these examples, the instructor or other staff may need to call on a student or participant by name, number, group identification, position, and other similar designations. Nametags that are attached to clothing or otherwise worn are often too small to read from a distance. Nameplates placed on desks may also be too small or be obstructed from view by other students sitting between a target student and the instructor. Additionally, these traditional methods of identification may be cumbersome, unattractive, and add to the clutter on the desk. Therefore, an effective and easy to use method of identification of participant in a group setting is highly desirable.

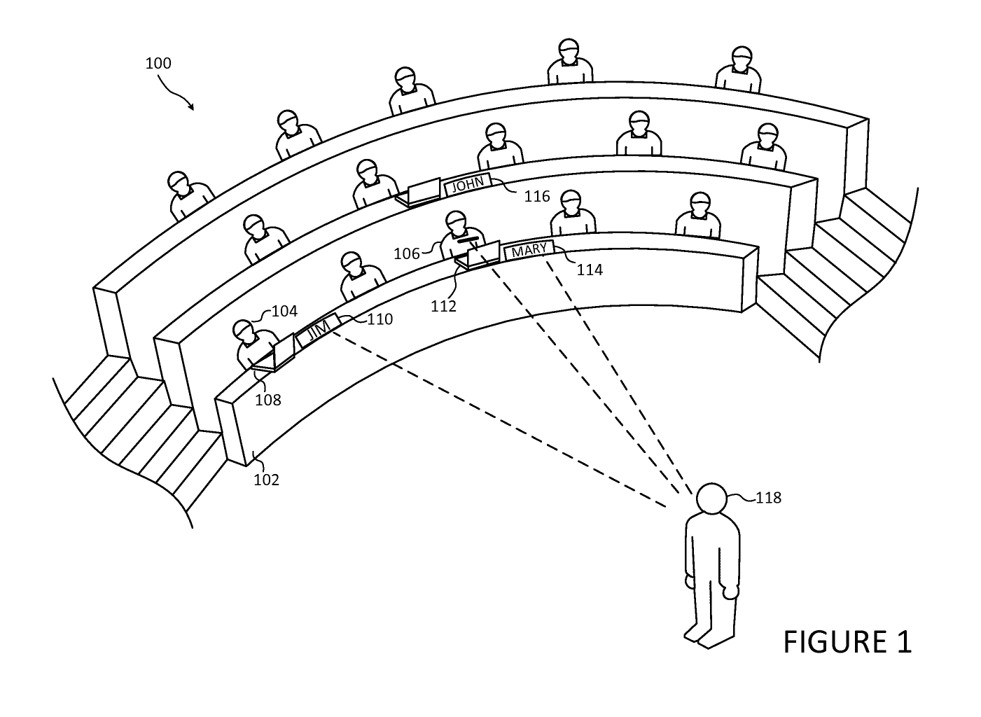

FIG. 1 shows an example large class environment where a configurable information tag may be used. In various embodiments, class environment 100 may include multiple rows of tables or desks 102, students 104 and 106, laptop computers 108 and 112, nameplates 110, 114, and 116, and instructor 114.

In such setting the instructor 114 may want to call on students from a distance much greater than the normal reading distance of about an arm's length. The instructor may easily see the nameplates 110 and 114 sitting low on the unobstructed desks, but may have difficulty seeing and/or reading nameplate 116 obstructed by student 106. A better placed nametag that is not as easily obstructed is desirable in this and other similar situations.

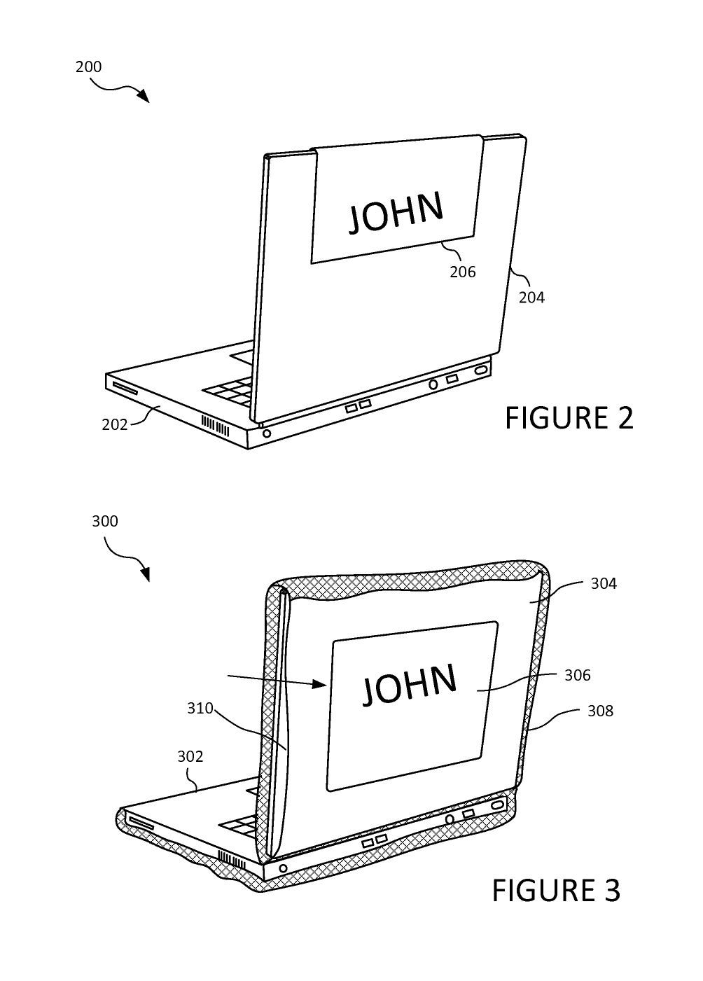

FIG. 2 shows an example laptop computer with a configurable information tag displaying a name. In various embodiments, laptop computer 200 may include keyboard 202, display 204, and configurable information tag 206.

In various embodiments, configurable information tag 206 may be coupled with an upper section of the display 204 of the laptop, in an open position, such that the tag is easily visible from a distance at least several times farther than normal reading distance of about an arm's length. In this arrangement, the nametag or other information tag is substantially raised above the surface of the desk, making it more visible by avoiding or reducing obstructions, such as another person sitting in front of the laptop, thus blocking the line of sight of others to the nametag. For example, in a large class student's and their name tags may be fully or partially obscured from the line of sight of the instructor who may wish to address them by name or by other identification, such as a number in an exam session. A large nametag affixed to the back of a laptop may provide a clearer and more easily visible view of the name to the instructor.

In various embodiments, the configurable information tag 206 may be label holder or assembly for holding and displaying separate paper labels, or may be a flat sheet itself made of paper, cardboard, plastic, thin metal, laminate sheets, composite material, and the like. In some embodiments, the information tag is relatively rigid, while in other embodiments, it is soft and flexible.

FIG. 3 shows an example laptop computer with a protective case having a built-in configurable information tag displaying a name. In various embodiments, laptop computer 300 may include keyboard 302, display 304, protective case 308 with slot 310, and information display window 306.

In various embodiments, the protective case 308 may have a slot to access the display window 306 to insert a paper or plastic name tag or other information tag. Such a display window or pocket built into the case allows carrying or moving the computer and the nametag around without the nametag falling off or have to be reattached. For example, a student in a college setting moving from one class to another, can simply take the computer and move without having to take the nametag off at the end of one class and then put it back on in the next class. Those skilled in the art will appreciate that the display window may be of any size and be placed anywhere on the protective case, even though it is shown in the center of the case in FIG. 3.

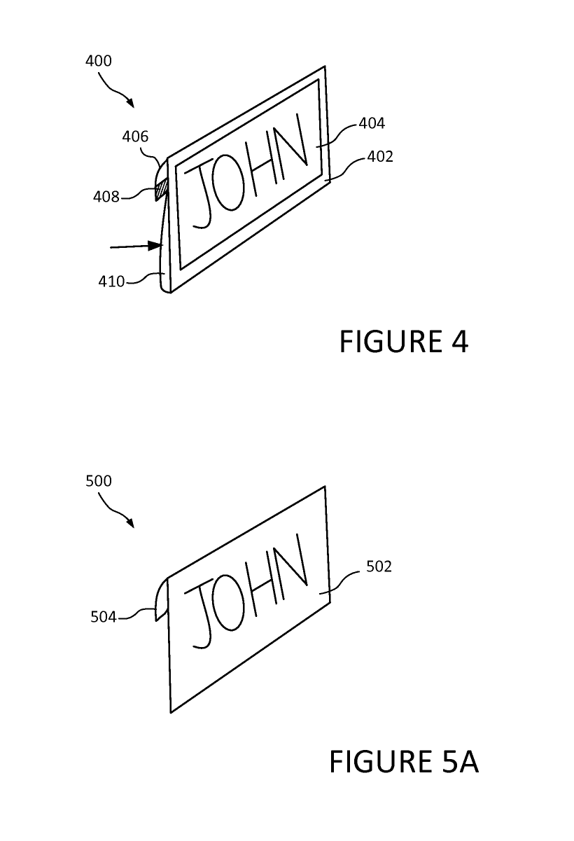

FIG. 4 shows an example configurable information tag with a slot for sliding in a paper label. In various embodiments, information tag 400 may include information display area 404, display side 402, hanging flap 406, adhesive area 408, and insertion slot 410.

In various embodiments, hanging flap 406 may be used to hang the information tag from the upper edge of a laptop computer as shown in FIG. 2. In some embodiments, the adhesive area 408 may be used to affix the tag onto the front edge or border of the computer screen (the user display side) to prevent the tag from shifting or falling off easily, for example, due to an air draft, movement of the computer, or other forces. Those skilled in the art will appreciate that the slot 410 may be on the side, top, or otherwise provide access to the display area 404 for inserting a paper or plastic information tag.

In various embodiments, the adhesive force of the adhesive area 408 may be a due to a mild reusable glue, a film sensitive to static electricity, a soft film configured to adhere to a surface via creation of vacuum between the adhesive area and the surface, and the like. Static electricity may be used to create adhesion between the tag and the surface due to attractive forces between positive and negative electric charges accumulated on the static-sensitive film.

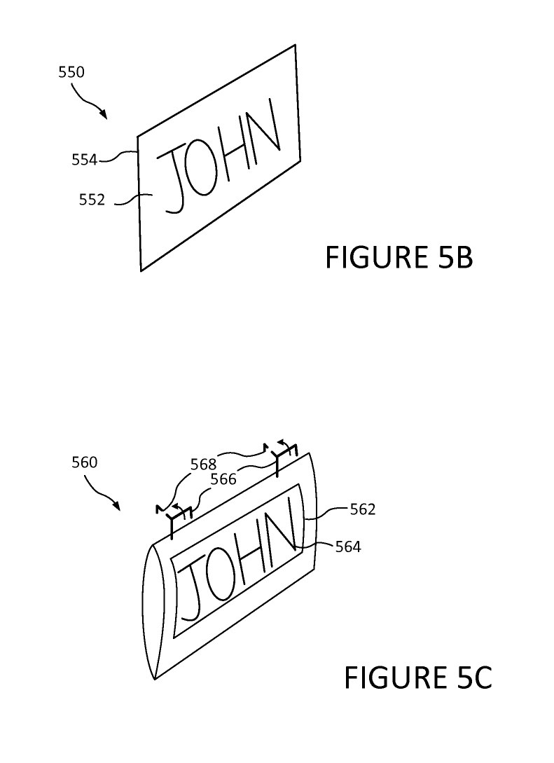

FIG. 5A shows an example information tag having a folded hanging edge. In various embodiments, information tag 500 may include information display area 502 and hanging flap 504.

In various embodiments, hanging flap 504 may be used to hang the information tag from the upper edge of a laptop computer as shown in FIG. 2. In some embodiments, an adhesive area, similar to adhesive are 408 shown in FIG. 4, may be used to affix the tag onto the front edge or border of the computer screen (the user display side) to prevent the tag from shifting or falling off easily, for example, due to an air draft, movement of the computer, or other forces.

FIG. 5B shows an example information tag with an adhesive side. In various embodiments, information tag 550 includes a display side 552 and adhesive side 554.

In various embodiments, the information tag 550 is a thin sheet made from paper, plastic, nylon, or other suitable material. The adhesive force of the adhesive side 554 may be a due to a mild reusable glue, a film sensitive to static electricity, a soft film configured to adhere to a surface by creating vacuum between the adhesive layer and the surface, and the like. Static electricity may be used to create adhesion between the tag and the surface due to attractive forces between positive and negative electric charges accumulated on the static-sensitive film.

FIG. 5C shows an example information tag with rotating hanging hooks. In various embodiments, information tag 560 includes label holder 562, information label 564, rotatable hooks 566 configured to open to position 568.

In various embodiments, rotatable hooks 566 are configured to rotate from a closed position to an open position 568, as indicated by the curved arrows, for hanging the label holder 562 from a support, such as the display screen of a laptop computer, similar to the arrangement shown in FIG. 2. In various embodiments, the rotatable hooks may be deployed within label holder 562 to allow manual rotation of the hooks to close or open positions. In other embodiments, the hooks may be a separate assembly affixed to the surface of the label holder.

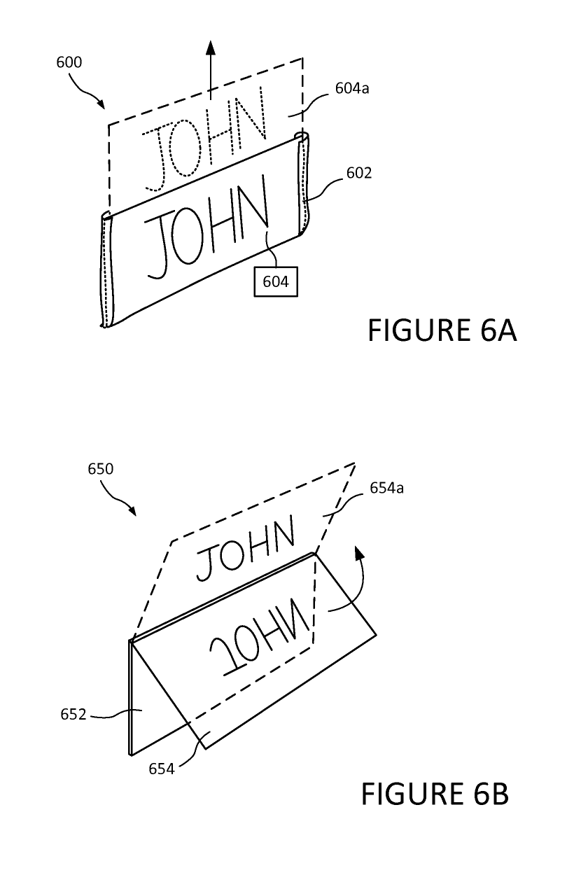

FIG. 6A shows an example extendable information tag configured to be slid up and down to increase visibility. In various embodiments, extendable information tag 600 includes thin frame 602, display area 604 extendable to extended display area 604a.

In various embodiments, an extendable information tag may be extended upwards away from the laptop keyboard an/or a desk surface to further enhance the visibility of the tag. In various embodiments, the thin frame 602 may have grooves with sufficient clamping and frictional force to hold a relatively rigid tag sheet having display area 604 thereon at a given position. The tag sheet may thus be extended in and out of the thin frame 602, as shown by the upward arrow, and be held in the extended position in which it is placed.

Those skilled in the art will appreciate that other mechanisms may be used to extend and hold the tag sheet without departing from the spirit of the present disclosures. For example, to hold the position of the tag sheet, a small manual clamp may be used to clamp the tag sheet to the frame or other types of base.

In various embodiments, information tag 600 is attached to the back of the computer by any of the methods described above with respect to FIGS. 3-5B.

FIG. 6B shows an example extendable information tag configured to be rotate or flip up and down to increase visibility. In various embodiments, information tag 650 may include a relatively rigid folded sheet 652 having a display flap 654 rotatably extendable to open position 654a.

In various embodiments, The information, such as a name or number, is written on the display flap and rotated to open and extend upward with respect to the keyboard of the laptop and/or the surface of the desk, as indicated by the curved arrow shown in FIG. 6B. The display flap may be held in position by various methods, such as a small lockable hinge, a friction hinge, a plastically bendable metal section deployed along the attached edge between the display flap 654 and the other segment of the folded sheet 652, and the like.

In various embodiments, information tag 650 is attached to the back of the computer by any of the methods described above with respect to FIGS. 3-5B.

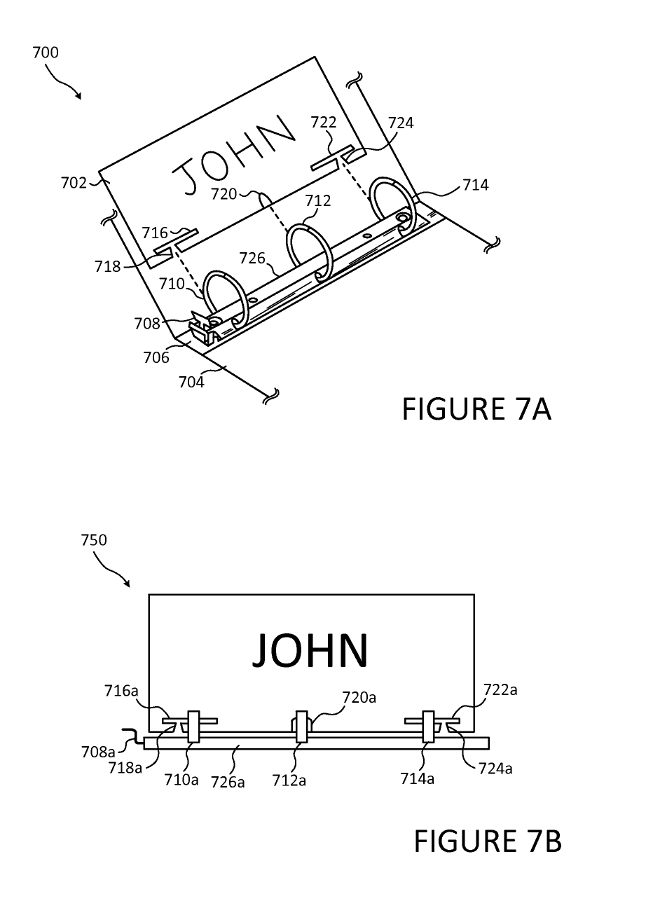

FIG. 7A shows an example information tag with slotted holes configured for placing the information tag into a three-ring binder without opening the rings. In various embodiments, three-ring binder arrangement 700 includes information tag 702 having side slotted holes 716 and 722, with entry funnels 718 and 724, respectively, and middle slot 720, configured to be placed in three-ring binder 706 having cover 704, ring assembly 726, ring opening lever 708, side rings 710 and 714, and middle ring 712.

In various embodiments, information tag 702 may be similar to any of the tags described above with respect to FIGS. 3-6B, with the additional feature of slotted holes for insertion into a three-ring binder. Existing split-hole sheets may be inserted into a three ring binder without opening the rings, however, the slit cut into the split-holes tends to lose its physical and structural integrity and get loose after a few uses and the sheet tends to be pulled out or fall out from the rings easily. This problem may be overcome by having horizontal slots such as side slotted holes 716 and 722 of FIG. 7A, which may be engaged with the rings one at a time to quickly and securely insert the information tag into the binder 706.

In operation, in some embodiments, a side slotted hole 716 (or 722) may be engaged with the corresponding ring 710 (or 714) by inserting the closed ring into the entry funnel 718. Once inside the slot 716, information tag 702 may be slid to the left, making ring 710 move to the right side of slot 716. The distance between entry funnel 718 and 724 are set to be less than the distance between rings 710 and 714. Next, the other side slotted hole 722 (or 716) is engaged with its corresponding ring 714 (or 710) by inserting closed ring into the entry funnel 724. Finally, the middle slot is engaged with the middle ring to prevent the side slots from shifting left or right and cause disengagement from the rings in the binder. The two side slotted holes may also be engaged with their respective rings simultaneously by softly bending or arching the information tag to bring the entry funnels 718 and 724 closer to each other and line them up with the respective side rings. Then, all three rings may be inserted simultaneously into the respective side and center holes.

FIG. 7B shows the example information tag of FIG. 7A as placed in the three-ring binder without opening the rings. In various embodiments, three-ring binder arrangement 750 includes information tag having side slotted holes 716a and 722a, with entry funnels 718a and 724a, respectively, and middle slot 720a, after having been placed in the three-ring binder with ring assembly 726a, ring opening lever 708a, side rings 710a and 714a, and middle ring 712a.

In various embodiments, side rings 710a and 714a are positioned into side slotted holes 716a and 722a, respectively, away from respective entry funnels 718a and 724a, so that the side rings cannot be come out of the side slotted holes without first disengaging the middle ring 712a from the middle slot 720a.

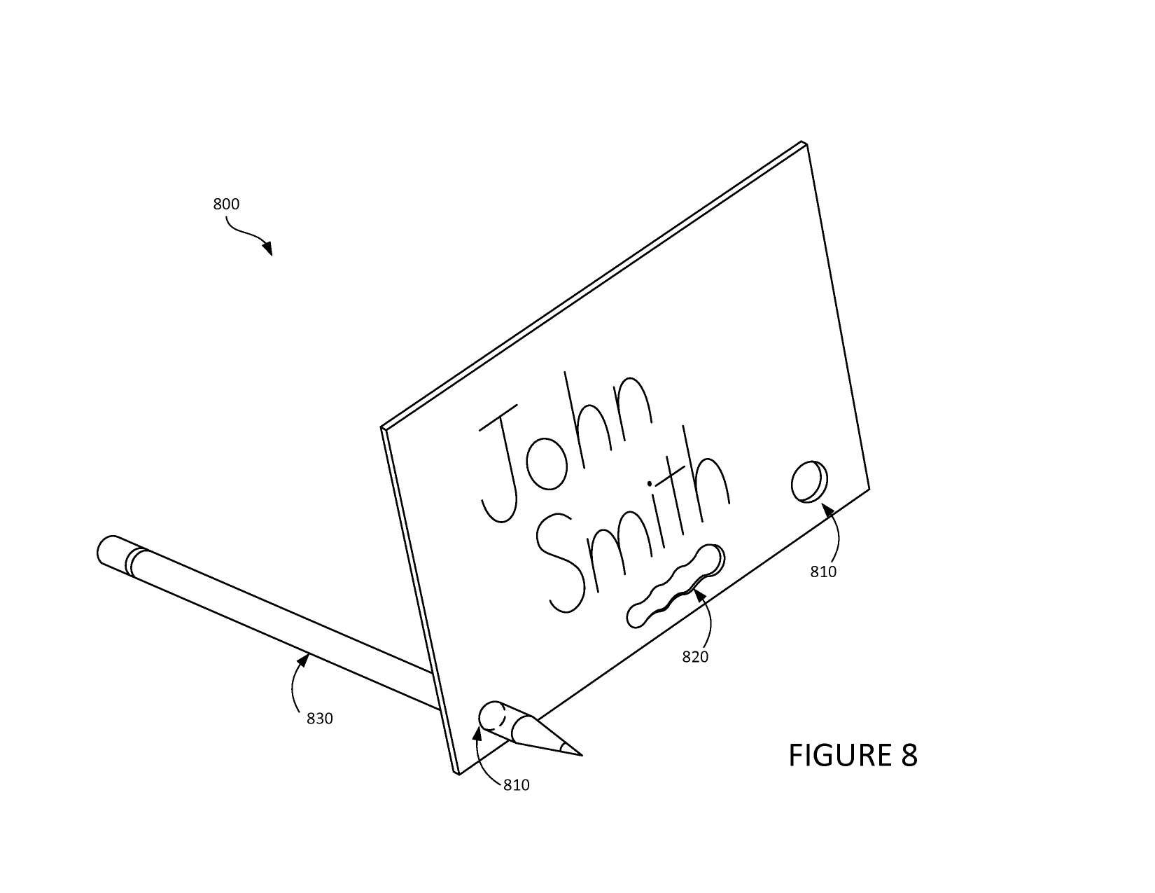

FIG. 8 shows an example information tag 800 having two holes 810 and a slot 820 for holding personal items, such as pencil 830, which act as a stand for the information tag. Information tag 800 may be easily carried in a bag or even between the pages of a notebook or in a three-ring binder. Information tag 800 may also be displayed on a desk or table, substantially vertically, just by placing a pen or pencil 830 in one of its holes 810, which may have different diameters for different size pens and pencils. Other instruments such as a chopstick may also be used as a stand for tag 800. In some embodiments holes 810 may have different shapes for holding other objects, such as spoons and knives, as stands.

In various embodiments tag 800 may have a progressively widening slot 820 instead of or in addition to the holes 810, wherein, depending on the position of stand 830 within slot 820, the angle of tag 800 with respect to the surface underneath it can be adjusted. For example a pencil placed in the narrowest part of slot 820 creates a large angle while placing the same pencil in the widest part of slot 820 forms a small angle between the tag surface and the table surface. The edges of slot 820 may be smooth or corrugated, having ridges and grooves, such the example slot illustrated in FIG. 800. Slot 820 also allows different size and shape objects to be used as a stand for tag 800.

In some embodiments the longitudinal axis of a long object inserted into holes 810 and/or slot 820 may be perpendicular to the surface plane of tag 800 and in other embodiments the longitudinal axis of a long object inserted into holes 810 and/or slot 820 may not be perpendicular to the surface plane of tag 800.

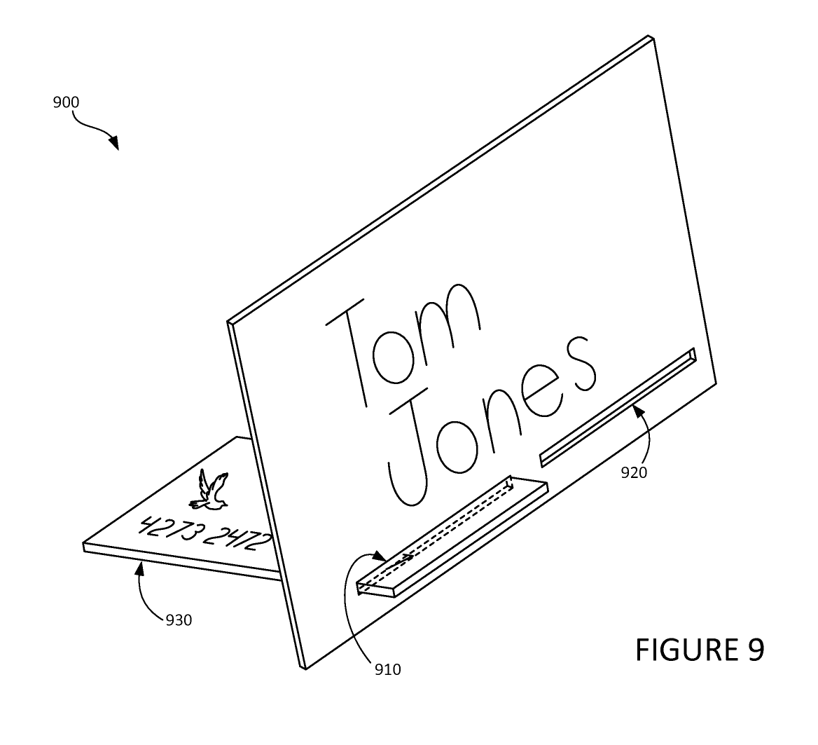

FIG. 9 shows an example information tag 900, made of a rigid or a semi-rigid thin sheet of material, having slits 910 and 920 to hold credit cards or business cards as a stand 930 for tag 900. Information tag 900 may be easily carried in a bag or even between the pages of a notebook or in a three-ring binder. Information tag 900 may also be displayed on a desk or a table, substantially vertically, just by placing a credit card or a business card 930 in one of the slits 910 or 920. Other instruments such as a pocket knife may also be used as a stand for tag 900.

In some embodiments slit 920 may have a progressively increasing width and be used instead of or in addition to the slit 910, wherein, depending on the position of stand 930 within slit 920, the angle of tag 900 with respect to a surface underneath can be adjusted. For example a credit card places toward the narrowest part of slit 920 creates a large angle while placing the same credit card toward the widest part of slit 920 forms a small angle. Slit 920 also allows different size and shape objects to be used as a stand for tag 900.

In some embodiments the surface plane of the credit card or the business card inserted into slits 910 and 920 may be perpendicular to the surface plane of tag 900 and in other embodiments the surface plane of the credit card or the business card inserted into slits 910 and 920 may not be perpendicular to the surface plane of tag 900.

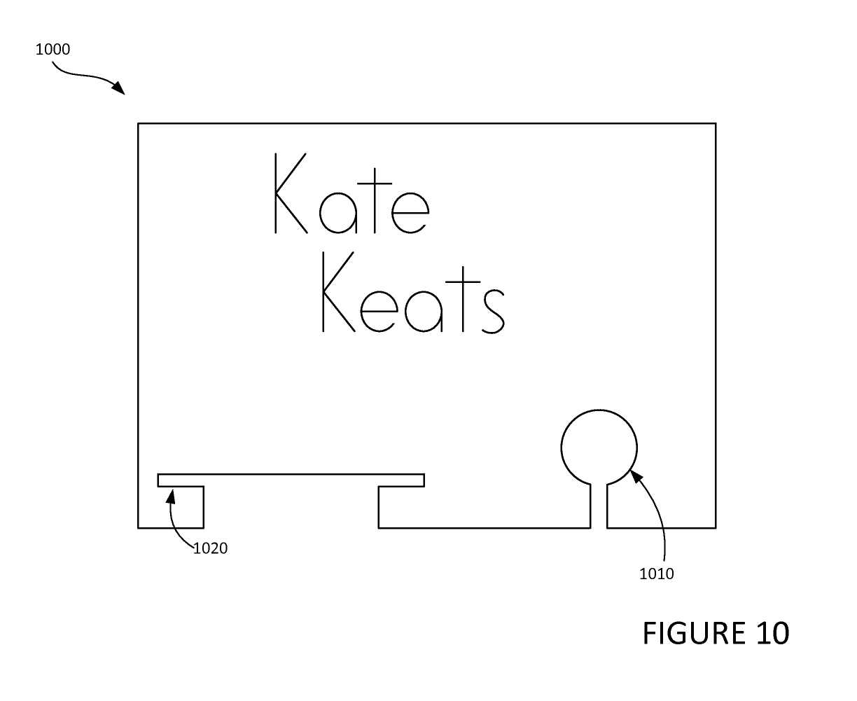

As illustrated in FIG. 10, an information label 1000 may have an open hole 1010 instead of or in addition to the closed holes 810 of tag 800 in FIG. 8, and may have an open slit 1020 instead of or in addition to the closed slits 910 and 920 of tag 900 in FIG. 9.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

1. A desktop-information-tag comprising a rigid or a semi-rigid thin sheet of material over which identifying information is printed or hand written and which includes an open or a closed hole, slot, and/or slit for placing an object within the hole, the slot, and/or the slit to form a stand that keeps the sheet of material substantially upright on a flat surface, wherein the tag stays substantially upright only by forces exerted by the object on at least a part of circumference of the hole, the slot, and/or the slit.

2. The desktop-information-tag of claim 1, wherein the sheet of material is further configured to be extended to enhance visibility of the identifying information from a distance.

3. The desktop-information-tag of claim 1, further comprising a folded flap for hanging the information tag from an edge of a display of the laptop computer.

4. The desktop-information-tag of claim 3, wherein the flap includes an adhesive area.

5. The desktop-information-tag of claim 1, further comprising a thin frame configured to hold the rigid sheet material in an extended position.

6. The desktop-information-tag of claim 1, further comprising a folded flap configured to be rotatably extended to display the recorded information on the rigid sheet material.

7. The desktop-information-tag of claim 1, wherein the information tag is also configured to be attached to the display of the laptop computer using one of static electricity and vacuum force.

8. The desktop-information-tag of claim 1, wherein the angle between a tag surface and the flat surface depends on the positioning of the object within the hole, the slot, and/or the slit.

9. The desktop-information-tag of claim 1, wherein the object is a pen, a pencil, a writing instrument, a credit card, a business card, a knife, or a utensil.

10. A method of identifying a person at a desk or a table, the method comprising:
writing an identifying information of the person on a rigid or a semi-rigid thin flat sheet of material to be used as an information label;
forming an open or a closed hole, slot and/or slit through the sheet of material;
placing an object in the hole, the slot and/or the slit of the sheet of material to create a stand for the sheet of material; and
placing the engaged sheet of material and the object on a substantially horizontal surface of the desk or table such that the sheet of material is at a substantially upright position with respect to the surface over which the sheet of material is placed, wherein the tag stays substantially upright only by forces exerted by the object on at least a part of circumference of the hole, the slot, and/or the slit.

11. The method of claim 10, further comprising extending the information label to allow better visibility of the information label.

12. The method of claim 10, wherein the information label is configured to be extended upward.

13. The method of claim 10, wherein the information label is configured to be extended by rotatably extending a folded label upward.

14. The method of claim 10, wherein the angle between the label surface plane and the plane of the flat surface depends on the positioning of the object within the hole, the slot, and/or the slit.

15. The method of claim 10, wherein the object is a pen, a pencil, a writing instrument, a credit card, a business card, a knife, or a utensil.
